(19) United States
(12) Patent Application Publication
(10) Pub. No.: US 2020/0102472 A1
(43) Pub. Date: Apr. 2, 2020

(54) COMPOSITIONS USEFUL FOR FORMING SOFT TOUCH COATINGS

(71) Applicant: Arkema France, Colombes (FR)

(72) Inventors: Lisa Marie Spagnola, Richboro, PA (US); Jeffrey A. Klang, West Chester, PA (US); Manjuli Gupta, Easton, PA (US); William C. Wolf, Philadeljpia, PA (US)

(21) Appl. No.: 16/498,497

(22) PCT Filed: Mar. 12, 2018
(86) PCT No.: PCT/EP2018/056028

§ 371 Date: Sep. 27, 2019

Related U.S. Application Data
(60) Provisional application No. 62/477,606, filed on Mar. 28, 2017.

(51) Int. Cl. C09D 171/02; C09D 147/00; C08F 220/18; C08G 65/18; C08L 83/04; C08K 3/36; C08K 5/132; C08K 5/07; C08K 5/5397; C08K 5/01; C08K 7/22

(52) U.S. Cl. CPC C09D 171/02; C09D 147/00; C08F 220/18; C08G 65/18; C08L 83/04; C08K 3/36; C08L 2312/06; C08K 5/07; C08K 5/5397; C08K 5/01; C08K 7/22; C08F 2810/40; C08K 5/132

(57) ABSTRACT

“Soft feel” coatings are obtained by curing a coating composition containing a) at least one (meth)acrylate-functionalized oxetane/oxolane oligomer such as a (meth)acrylate-functionalized polytetramethylene ether, b) at least one radiation-curable compound (other than (meth)acrylate-functionalized oxetane/oxolane oligomer) and c) at least one surface conditioner additive selected from the group consisting of particulate surface modification agents and slip additives. As a consequence of containing (meth)acrylate-functionalized oxetane/oxolane oligomer, the coating composition has advantageously low viscosity and yet is capable of providing a cured coating having excellent haptic properties.

The present invention relates to radiation-curable compositions useful for forming substrate coatings having a desirable “soft” touch or feel.

Products with a soft feel coating or soft touch coating are desirable, as such coatings provide a more pleasing, luxurious feel to plastic, metal or other hard substrates. Conventional soft feel coatings have been based upon solvent- or water-borne two-part systems with polyurethane chemistry. While such coatings are advantageous with respect to feel, such coatings suffer from drawbacks including difficulties in formulating, limited shelf-life, long curing times and poor protective properties such as stain, chemical, abrasion and mar resistance. Consequently, it would be desirable to improve such coatings, in particular to find ways in which such coatings may be formulated to simultaneously provide prolonged storage stability (i.e., enhanced shelf life) and shorter cure times.

Representative examples of “soft feel” coating formulations known in the art may be summarized as follows:

DE 202012012632 discloses a UV-curable soft feel coating for pen grips. In the examples, this publication is directed to a soft feeling coating obtained using a mixture of difunctional urethane acrylate oligomer and monofunctional monomer that is radiation curable.

JP 5000123 discloses the synthesis of a urethane acrylate oligomer which is capable of being used to create a radiation-curable coating.

JP 4778249B2 discloses a formulation that includes an acrylated silicone oligomer for a leather-type paint.

CN 102850922 discloses a UV-curable pigmented coating that can be used on electronics which includes a “linear UV methyl acrylic resin”.

CN 104263034 describes a formulation for a soft touch coating which includes 15%-30% of an oligomer, wherein the oligomer can be a urethane acrylate, epoxy soybean oil-modified acrylate, polyester acrylate or an amine-modified resin.

There has been interest in developing radiation-curable systems to replace the isocyanate-based polyurethane soft touch coatings that have conventionally been used. This is because radiation-curable systems do not contain free isocyanate (which may create certain health and safety risks), potentially provide improved durability, have effectively unlimited pot life, can be formulated to be free of water and non-reactive solvents (while still having suitably low viscosity in the uncured state) and can be cured more quickly (in seconds, rather than the minutes to hours typically needed for conventional polyurethane soft touch coatings). However, radiation-curable systems have certain challenges with respect to their use as soft feel coatings.

One issue that has been encountered is that certain of the radiation-curable coating compositions recognized as providing superior quality soft touch coatings when cured have relatively high viscosities, due to the components which must be used in such compositions. Although solvents or other volatile liquid carriers may be used to reduce viscosity, this approach is not ideal since the solvent or liquid carrier must be removed following application of the coating composition to a substrate surface. This complicates the coating process; additionally, at least certain solvents have environmental and/or worker exposure concerns. Thus, it would be desirable to develop solvent-free or low solvent coating compositions which have low viscosity at ambient temperature (e.g., 25° C.) and yet form a coating having acceptable soft touch qualities once cured.

It has now been discovered that incorporating one or more (meth)acrylate-functionalized oxetane/oxolane oligomers (for example, one or more (meth)acrylate-functionalized tetramethylene ethers) into a coating composition which also contains one or more radiation-curable compounds (other than the (meth)acrylate-functionalized oxetane/oxolane oligomers), one or more surface conditioner additives and, optionally, one or more photoinitiators provides a coating composition of advantageously low viscosity, permitting the coating composition to be easily handled and applied to a substrate surface. At the same time, the presence of the (meth)acrylate-functionalized oxetane/oxolane oligomer leads to the production of a cured coating derived from the coating composition which is soft to the touch and generally satisfactory for use as a soft touch coating.

Various non-limiting aspects of the invention may be summarized as follows:

Aspect 1: A coating composition useful for forming a soft touch coating on a surface of a substrate, wherein the coating composition comprises a) at least one (meth)acrylate-functionalized oxetane/oxolane oligomer (e.g., at least one (meth)acrylate-functionalized polytetramethylene ether), b) at least one radiation-curable compound other than (meth)acrylate-functionalized oxetane/oxolane-functionalized oligomer, c) at least one surface conditioner additive selected from the group consisting of slip additives and particulate surface modification agents, and, d) optionally, at least one photoinitiator, preferably said photoinitiator d) being either one photoinitiator which absorbs both long and short wavelength ultraviolet radiation or said photoinitiator d) is comprising a first photoinitiator which absorbs long wavelength ultraviolet radiation and a second photoinitiator which absorbs short wavelength ultraviolet radiation.

Aspect 2: The coating composition of Aspect 1, wherein the at least one (meth)acrylate-functionalized oxetane/oxolane oligomer a) is a di(meth)acrylate-functionalized oxetane/oxolane oligomer (e.g., a di(meth)acrylate-functionalized polytetramethylene ether).

Aspect 3: The coating composition of Aspect 1 or 2, wherein the at least one (meth)acrylate-functionalized oxetane/oxolane oligomer a) is an acrylate-functionalized oxetane/oxolane oligomer (e.g., an acrylate-functionalized polytetramethylene ether).

Aspect 4: The coating composition of Aspect 1, wherein the at least one (meth)acrylate-functionalized oxetane/oxolane oligomer a) corresponds to formula (I):

H₂C═C(R)C(═O)—O—[(CH₂)ₓ—O]ₙC(═O)C(R′)═CH₂ (I)

wherein R and R′ are independently selected from the group consisting of hydrogen and methyl, x is 3 or 4 (with the understanding that x may vary between individual repeating units) and n is an integer of from 2 to 100.

Aspect 5: The coating composition of Aspect 4, wherein R and R′ are both hydrogen.

Aspect 6: The coating composition of Aspect 4, wherein the at least one (meth)acrylate-functionalized oxetane/oxolane oligomer a) is a mixture of (meth)acrylate-functionalized oxetane/oxolane oligomers (e.g., (meth)acrylate-functionalized polytetramethylene ethers) of formula (I) wherein n on average in the mixture is from about 3 to about 42 on average as calculated by number average.

Aspect 7: The coating composition of any of Aspects 1 to 6, wherein the at least one (meth)acrylate-functionalized oxetane/oxolane oligomer a) (e.g., (meth)acrylate-functionalized polytetramethylene ether) is from about 40% to about 95% by weight of the total amount a)+b) of (meth)acrylate-functionalized oxetane/oxolane oligomer(s) a) and radiation-curable compound(s) b) other than (meth)acrylate-functionalized oxetane/oxolane-functionalized oligomer (“other radiation-curable compound(s)”) in the coating composition.

Aspect 8: The coating composition of any of Aspects 1 to 7, wherein the at least one surface conditioner additive c) comprises at least one slip additive selected from the group consisting of polysiloxanes, natural and synthetic waxes and fluoropolymers, wherein the slip additive may optionally comprise at least one radiation-curable double bond.

Aspect 9: The coating composition of any of Aspects 1 to 8, wherein the at least one surface conditioner c) additive comprises at least one polysiloxane selected from the group consisting of silicone polyether copolymers and silicone acrylates.

Aspect 10: The coating composition of any of Aspects 1 to 9, wherein the coating composition is comprised of from 0.2 to 20 percent by weight slip additive.

Aspect 11: The coating composition of any of Aspects 1 to 10, wherein the at least one radiation-curable compound b) other than (meth)acrylate-functionalized oxetane/oxolane-functionalized oligomer, comprises at least one (meth)acrylate-functionalized substance selected from the group consisting of (meth)acrylate esters of aliphatic mono-alcohols, (meth)acrylate esters of alkoxylated aliphatic mono-alcohols, (meth)acrylate esters of aliphatic polyols, (meth)acrylate esters of alkoxylated aliphatic polyols, (meth)acrylate esters of aromatic ring-containing alcohols, (meth)acrylate esters of alkoxylated aromatic ring-containing alcohols, epoxy (meth)acrylates, polyether (meth)acrylates, urethane (meth)acrylates, polyester (meth)acrylates and amine- and sulfide-modified derivatives thereof and combinations thereof and combinations thereof.

Aspect 12: The coating composition of any of Aspects 1 to 11, wherein the coating composition is comprised of 50 to 99 percent by weight in total of (meth)acrylate-functionalized oxetane/oxolane oligomer a) (e.g., (meth)acrylate-functionalized polytetramethylene ether) and radiation-curable compound b) other than (meth)acrylate-functionalized oxetane/oxolane oligomer.

Aspect 13: The coating composition of any of Aspects 1 to 12, wherein the at least one radiation-curable compound b) other than (meth)acrylate-functionalized oxetane/oxolane oligomer, comprises at least one (meth)acrylate-functionalized substance selected from the group consisting of and di(meth)acrylate-functionalized aliphatic diols which includes di(meth)acrylate-functionalized alkoxylated aliphatic diols.

Aspect 14: The coating composition of any of Aspects 1 to 13, wherein the at least one radiation-curable compound b) other than (meth)acrylate-functionalized oxetane/oxolane oligomer, comprises at least one (meth)acrylate-functionalized substance selected from the group consisting of di(meth)acrylate-functionalized propoxylated neopentyl glycol and di(meth)acrylate-functionalized C₈-C₂₂ aliphatic diols.

Aspect 15: The coating composition of any of claims 1 to 14, wherein the coating composition is comprised of 50 to 99 percent by weight in total of (meth)acrylate-functionalized oxolane/oxetane oligomer a) and of radiation-curable compound b). Aspect 16: The coating composition of any of Aspects 1 to 15, wherein the at least one surface conditioner additive c) comprises at least one particulate surface modification agent selected from the group consisting of silicas, polymer beads and wax particles.

Aspect 17: The coating composition of any of Aspects 1 to 16, wherein the coating composition is comprised of from 0.2 to 30 percent by weight particulate surface modification agent.

Aspect 18: The coating composition of any of Aspects 1 to 17, wherein the coating composition comprises at least one slip additive and at least one particulate surface modification agent.

Aspect 19: The coating composition of any of Aspects 1 to 18, wherein the coating composition comprises at least one slip additive and at least one silica as a particulate surface modification agent.

Aspect 20: The coating composition of any of Aspects 1 to 19, wherein the coating composition comprises at least one polysiloxane as a slip additive and at least one silica as a particulate surface modification agent.

Aspect 21: The coating composition of any of Aspects 1 to 20, wherein coating composition comprises at least one photoinitiator and wherein the at least one photoinitiator comprises at least one photoinitiator selected from the group consisting of alpha-hydroxy ketones, phenylglyoxylates, benzyldimethylketals, alpha-aminoketones, mono-acyl phosphines, bis-acyl phosphines, metallocenes, phosphine oxides, benzoin ethers and benzophenones and combinations thereof.

Aspect 22: The coating composition of any of Aspects 1 to 21, wherein the coating composition comprises a single photoinitiator which is capable of absorption of both short wavelength ultraviolet radiation and long wavelength ultraviolet radiation.

Aspect 23: The coating composition of any of Aspects 1 to 22, wherein the coating composition is comprised of from 0.1 to 10 percent by weight photoinitiator.

Aspect 24: The coating composition of any of Aspects 1 to 23, wherein the coating composition is comprised of a first photoinitiator which is capable of absorption of short wavelength ultraviolet radiation and a second photoinitiator which is capable of absorption of long wavelength ultraviolet radiation.

Aspect 25: The coating composition of any of Aspects 1 to 24, wherein the coating composition is free or essentially free of non-reactive solvent and water (e.g., the coating composition is comprised of not more than 1% by weight in total of non-reactive solvent and water).

Aspect 26: A method of forming a soft touch coating on a surface of a substrate, comprising applying a layer of the coating composition of any of Aspects 1 to 25 to at least a portion of the surface and curing the coating composition by irradiation (e.g., by exposing the coating composition to at least one source of radiation, such as electron beam radiation and/or ultraviolet radiation).

Aspect 27: The method of Aspect 26, wherein the substrate is comprised of a material selected from the group consisting of thermoplastics, thermoset resins, ceramics, cellulosic materials, leather and metals.

Aspect 28: The method of Aspect 26 or 27, wherein the layer of the coating composition has a thickness of from 10 to 75 microns.

Aspect 29: The method of any of Aspects 26 to 28, wherein the layer of the coating composition is cured by first exposing the layer of the coating composition to long wavelength ultraviolet radiation and then exposing the layer of the coating composition to short wavelength ultraviolet radiation (wherein the coating composition is comprised of at least one photoinitiator which absorbs both long wavelength ultraviolet radiation or is comprised of a first photoinitiator which absorbs long wavelength ultraviolet radiation and a second photoinitiator which absorbs short wavelength ultraviolet radiation).

Aspect 30: A substrate having a soft touch coating obtained by curing a coating composition in accordance with any of Aspects 1 to 25.

In certain embodiments, the present invention provides a coating composition wherein radiation-curable compounds (e.g., one or more (meth)acrylate-functionalized monomers and/or oligomers), including a) at least one (meth)acrylate-functionalized oxetane/oxolane oligomer (such as a (meth)acrylate-functionalized polytetramethylene ether) and b) radiation-curable compounds other than a), are combined with at least one surface conditioner additive c) selected from the group consisting of slip additives and particulate surface modification agents and, d) optionally, at least one photoinitiator (particularly where the composition is to be UV-cured). Such compositions are capable of being cured using a radiation source such as ultraviolet and/or electron beam radiation, wherein curing of the radiation-curable compound(s) due to free radical polymerization or other reaction involving the radiation-curable compound(s) takes place. A coating of the composition may preferably be applied to a surface of a substrate at ambient temperature or near ambient temperature, such as in the range of 10-35° C., although higher application temperatures could be used if so desired. Once applied, the composition may be cured, using for example ultraviolet (UV) light from one or more suitable sources and/or electron beam radiation.

For example, where the coating is to be cured using ultraviolet radiation, the layer of coating composition may be exposed to UV light for a time effective to cause cross-linking/polymerization of the (meth)acrylate-functionalized oxetane/oxolane oligomer a) and the other radiation-curable compound(s) b). The intensity and/or wavelength of the UV light may be adjusted as desired to achieve the desired extent of curing. The time period(s) of exposure is or are not particularly limited, so long as the time period(s) is or are effective to cure the coating composition into a viable article. Time frames for exposure to energy to cause sufficient cross-linking are not particularly limited and may be from several seconds to several minutes. The photoinitiator or photoinitiators may be selected so as to be activated at the wavelength(s) of the UV light to which the coating composition layer is exposed, whereby the UV light triggers decomposition of the photoinitiator and generates free radicals which initiate curing (e.g., polymerization and crosslinking) of the (meth)acrylate-functionalized oxetane/oxolane oligomer(s) a) and other radiation-curable compound(s) b). In various embodiments, the coating compositions described herein are liquid at ambient temperature (25° C.) with a viscosity of less than 4000 mPa·s (cP) or less than 3500 cP or less than 3000 cP or less than 2500 cP or less than 2000 cP or less than 1500 cP or, most preferably, less than 1000 cP. The coating compositions may have viscosities at 25° C. ranging from about 500 cP to about 4000 cP or from about 300 cP to about 2000 cP or from about 400 cP to about 1500 cP or from about 400 cP to about 1000 cP, as measured using a Brookfield viscometer, model DV-II, using a 27 spindle (with the spindle speed varying typically between 50 and 200 rpm, depending on viscosity). Such viscosities of the coating compositions described herein facilitate easy spreading of the compositions on a substrate for application as coatings and films.

The coating compositions may be applied to a substrate surface in any known conventional manner, for example, by spraying, knife coating, roller coating, casting, drum coating, dipping and the like and combinations thereof. Indirect application using a transfer process may also be used. A substrate may be any commercially relevant substrate, such as a high surface energy substrate or a low surface energy substrate, such as a metal substrate or plastic substrate, respectively. The substrates may comprise metal, cellulosic materials (such paper, cardboard and wood), ceramics (including glass), thermoplastics such as polyolefins, polycarbonate, acrylonitrile butadiene styrene (ABS) and blends thereof, polyamides, polyurethanes, polyesters composites (including laminates), thermosets, leather and combinations thereof.

### (Meth)acrylate-Functionalized Oxetane/Oxolane Oligomers a)

The coating compositions of the present invention are characterized by comprising, in addition to certain other components, one or more (meth)acrylate-functionalized oxetane/oxolane oligomers. Incorporating such (meth)acrylate-functionalized oxetane/oxolane oligomers into the coating compositions has been discovered to make possible the formulation of coating compositions which have advantageously low viscosities at ambient temperatures (e.g., 25° C.) and which when cured are capable of providing soft touch coatings on substrates that have desirable haptic qualities.

Without limiting or specifying the method by which they are actually produced, the (meth)acrylate-functionalized oxetane/oxolane oligomers suitable for use in the present invention may be generally described as oligomers or polymers of tetrahydrofuran (oxolane) and/or 1,3-propylene oxide (oxetane) bearing at least one (meth)acrylate functional group per molecule. Alternatively, they may be characterized as poly(1,4-butanediol) glycols, poly(1,3-propanediol) glycols or poly(1,4-butanediol-co-1,3-propanediol) glycols which have been at least partially esterified with (meth)acrylic acid or as (meth)acrylic esters of poly(trimethylene ether) glycols, poly(tetramethylene ether) glycols or poly(trimethylene ether-co-tetramethylene ether) glycols. The backbone of the oligomer may be an oxolane homopolymer, an oxetane homopolymer or an oxetane/oxolane copolymer, having for example a degree of polymerization (number of repeating units of —CH₂CH₂CH₂—O— and/or —CH₂CH₂CH₂CH₂—O—) of from 2 to 100 or 3 to 42. In a preferred embodiment, the (meth)acrylate-functionalized oxetane/oxolane oligomer is a (meth)acrylate-functionalized polytetramethylene ether. In another preferred embodiment, the (meth)acrylate-functionalized oxetane/oxolane oligomer (in particular, a (meth)acrylate-functionalized polytetramethylene ether) is difunctional and contains two (meth)acrylate functional groups per molecule. As used herein, the term “(meth)acrylate” includes both acrylate (—C(═O)CH═CH₂) and methacrylate (—C(═O)C(CH₃)═CH₂) functional groups. In one embodiment of the invention, an acrylate-functionalized polytetramethylene ether is used in the coating composition. Typically, the (meth)acrylate functional groups appear at terminal ends of a polytetramethylene ether moiety, polytrimethylene ether moiety or polytetramethylene ether-co-trimethylene ether moiety. In one embodiment, such moiety (e.g., a polytetramethylene ether moiety) is linear and may be represented by the structural formula —[(CH₂)ₓO]ₙ—, wherein x is 3 or 4 (it being understood that x may vary from repeating unit to repeating unit) and n is an integer of 2 or more (e.g., 2 to 100 or 3 to 42).

The (meth)acrylate-functionalized oxetane/oxolane oligomer component employed in the coating compositions of the present invention may be an admixture comprising (meth)acrylate-functionalized oxetane/oxolane oligomer molecules of varying molecular weight and functionality. For example, the admixture may contain both di(meth)acrylate-functionalized polytetramethylene ether molecules and mono(meth)acrylate-functionalized polytetramethylene ether molecules. In one desirable embodiment, the admixture contains more di(meth)acrylate-functionalized oxetane/oxolane oligomer molecules than mono(meth)acrylate-functionalized oxetane/oxolane oligomer molecules. For example, the admixture may comprise 75 to 100% by weight di(meth)acrylate-functionalized oxetane/oxolane oligomer molecules (e.g., di (meth)acrylate-functionalized polytetramethylene ether molecules) and 0 to 25% by weight mono(meth)acrylate-functionalized oxetane/oxolane oligomer molecules (e.g., mono(meth)acrylate-functionalized polytetramethylene ether molecules). The average (meth)acrylate functionality of such an admixture may be, in various embodiments of the invention from about 1.7 to 2, from about 1.8 to 2 or from about 1.9 to 2 (meth)acrylate groups per molecule (meaning average in number (meth)acrylate functionality). The number average molecular weight of the (meth)acrylate-functionalized oxetane/oxolane oligomer component present in the coating compositions of the present invention may be, in various embodiments of the invention, from about 218 g/mole to about 10,000 g/mole, from about 300 g/mole to about 5000 g/mole or from about 350 g/mole to about 3500 g/mole.

In certain embodiments, the at least one (meth)acrylate-functionalized oxetane/oxolane oligomer corresponds to formula (I):

H₂C═C(R)C(═O)—O—[(CH₂)ₓ—O]ₙC(═O)C(R′)═CH₂ (I)

wherein R and R′ are independently selected from the group consisting of hydrogen and methyl, x is 3 or 4 (wherein the value of x may vary between individual repeating units —[(CH₂)ₓ—O]—) and n is an integer of from 2 to 100 (e.g., 3 to 50, 3 to 30, 4 to 15). R and R′ are both hydrogen in a preferred embodiment of the invention (i.e., the functional groups are both acrylate). In another preferred embodiment, x=4. The at least one (meth)acrylate-functionalized oxetane/oxolane oligomer may be a mixture of (meth)acrylate-functionalized oxetane/oxolane oligomers of formula (I) wherein n on average is from about 2 to about 100, about 3 to about 50, about 3 to about 42, about 3 to about 30 or about 4 to about 15 on average, as calculated by number average.

Typically, it will be desirable for the at least one (meth)acrylate-functionalized oxetane/oxolane oligomer to represent a substantial portion by weight of the total amount of radiation-curable substances present in the coating composition. For example, the at least one (meth)acrylate-functionalized oxetane/oxolane oligomer may be from about 40% to about 95% or from about 45% to about 75% by weight of the total amount of (meth)acrylate-functionalized oxetane/oxolane oligomer(s) and radiation-curable compound(s) other than (meth)acrylate-functionalized oxetane/oxolane oligomer in the coating composition. In other embodiments, the weight ratio of (meth)acrylate-functionalized oxetane/oxolane oligomer to radiation-curable compounds other than (meth)acrylate-functionalized oxetane/oxolane oligomer may be from 9:1 to 4:6, 8:2 to 4.5:5.5 or 7:3 to 5:4.

Methods of preparing (meth)acrylate-functionalized oxetane/oxolane oligomers (e.g., (meth)acrylate-functionalized polytetramethylene ethers) are well-known in the art and any of such methods may be adapted for use in synthesizing the (meth)acrylate-functionalized oxetane/oxolane oligomer component(s) of the inventive coating compositions. Suitable preparation methods are described, for example, in the following published documents: U.S. Pat. Nos. 3,660,532; 4,189,566 and 4,412,063; U.S. Pat. Publication Nos. 2010/0160538 and 2010/0159767; CN 103865055; EP 0090301 and Kress et al., “Polytetrahydrofuran with Acrylate and Methacrylate Endgroups,” Macromolecules Rapid Communications, 2, pages 427-434 (1981). In one suitable method, a polytetramethylene glycol (e.g., a THF (oxolane) polymer of appropriate molecular weight having terminal hydroxyl groups) or a polytrimethylene glycol (e.g., a 1,3-propylene oxide (oxetane) polymer of appropriate molecular weight having terminal hydroxyl groups), which may be prepared by condensation of 1,4-butanediol and/or 1,3-propanediol or by polymerization of one or more cyclic monomers such as oxetane and/or oxolane is esterified with (meth)acryloyl chloride, (meth)acrylic anhydride or (meth)acrylic acid. The polytetramethylene glycol or polytrimethylene glycol may have a number average molecular weight of from about 250 to about 3000 g/mol, for example. (Meth)acrylate-functionalized oxetane/oxolane oligomers suitable for use in the present invention are also available from commercial sources, such as the Sartomer division of Arkema.

### Radiation-Curable Compounds b)

The coating compositions of the present invention are further characterized by comprising at least one radiation-curable compound b) other than (meth)acrylate-functionalized oxetane/oxolane oligomer (a)). Such a radiation-curable compound or mixture of radiation-curable compounds b) may be included in the coating composition for the purpose of controlling the cross-link density of the cured coating obtained from the coating composition and/or controlling other properties and characteristics of the cured coating such as glass transition temperature (Tg), tensile strength, percent elongation, adhesion to substrate, chemical resistance, scratch resistance, hardness or modulus or properties and characteristics of the uncured coating composition such as viscosity. Radiation-curable compounds suitable for use in the present invention may be generally described as ethylenically unsaturated compounds containing at least one carbon-carbon double bond, in particular a carbon-carbon double bond capable of participating in a free radical reaction, in particular a reaction initiated by ultraviolet radiation. Such reactions may result in a polymerization or curing whereby the radiation-curable compound becomes part of a polymerized matrix or polymeric chain. In various embodiments of the invention, the radiation-curable compound may contain one, two, three, four, five or more carbon-carbon double bonds per molecule. Combinations of multiple ethylenically unsaturated compounds containing different numbers of carbon-carbon double bonds may be utilized in the coating compositions of the present invention. The carbon-carbon double bond may be present as part of an α,β-unsaturated carbonyl moiety, e.g., an α,β-unsaturated ester moiety such as an acrylate functional group or a methacrylate functional group. A carbon-carbon double bond may also be present in the radiation-curable compound in the form of a vinyl group —CH═CH₂ (such as an allyl group, —CH₂—CH═CH₂). Two or more different types of functional groups containing carbon-carbon double bonds may be present in the radiation-curable compound. For example, the radiation-curable compound may contain two or more functional groups selected from the group consisting of vinyl groups (including allyl groups), acrylate groups, methacrylate groups and combinations thereof.

The coating compositions of the present invention may, in various embodiments, contain one or more (meth)acrylate functional compounds capable of undergoing free radical polymerization (curing) initiated by exposure to ultraviolet or electron beam radiation. As used herein, the term “(meth)acrylate” refers to methacrylate (—O—C(═O)—C(CH₃)═CH₂) as well as acrylate (—O—C(═O)—CH═CH₂) functional groups. Suitable radiation-curable (meth)acrylates include compounds containing one, two, three, four or more (meth)acrylate functional groups per molecule; the radiation-curable (meth)acrylates may be oligomers or monomers or a combination of oligomer(s) and monomer(s).

Typically, the other radiation-curable compound(s) together with the (meth)acrylate-functionalized oxetane/oxolane oligomer(s) will comprise the majority by weight of the coating compositions useful in the present invention. For example, the coating composition may contain 50 to 99 weight % in total of (meth)acrylate-functionalized oxetane/oxolane oligomer +radiation-curable compound other than (meth)acrylate-functionalized oxetane/oxolane oligomer, such amounts being based on the total weight of the coating composition.

Any of the following types of compounds may, for example, be employed in the coating compositions of the present invention as the radiation-curable compound other than the (meth)acrylate-functionalized oxetane/oxolane oligomer (the “other radiation-curable compound”): monomers such as (meth)acrylate esters of aliphatic mono-alcohols, (meth)acrylate esters of alkoxylated aliphatic mono-alcohols, (meth)acrylate esters of aliphatic polyols, (meth)acrylate esters of alkoxylated aliphatic polyols, (meth)acrylate esters of aromatic ring-containing alcohols and (meth)acrylate esters of alkoxylated aromatic ring-containing alcohols and oligomers such as epoxy (meth)acrylates, polyether (meth)acrylates, urethane (meth)acrylates, polyester (meth)acrylates (including amine- and sulfide-modified derivatives thereof) and combinations thereof.

Suitable other radiation-curable compounds b) include both (meth)acrylate monomers and (meth)acrylate oligomers, examples of each of which are discussed in more detail below.

### Radiation-Curable (Meth)acrylate Oligomers b)

Suitable radiation-curable (meth)acrylate oligomers include, for example, polyester (meth)acrylates, epoxy (meth)acrylates, polyether (meth)acrylates, urethane (meth)acrylates (also sometimes referred to as polyurethane (meth)acrylates or urethane (meth)acrylate oligomers) and combinations thereof, as well as amine-modified and sulfide-modified variations thereof.

Exemplary polyester (meth)acrylates include the reaction products of acrylic or methacrylic acid or mixtures thereof with hydroxyl group-terminated polyester polyols. The reaction process may be conducted such that a significant concentration of residual hydroxyl groups remain in the polyester (meth)acrylate or may be conducted such that all or essentially all of the hydroxyl groups of the polyester polyol have been (meth)acrylated. The polyester polyols can be made by polycondensation reactions of polyhydroxyl functional components (in particular, diols) and polycarboxylic acid functional compounds (in particular, dicarboxylic acids and anhydrides). To prepare the polyester (meth)acrylates, the hydroxyl groups of the polyester polyols are then partially or fully esterified by reacting with (meth)acrylic acid, (meth)acryloyl chloride, (meth)acrylic anhydride or the like. Polyester (meth)acrylates may also be synthesized by reacting a hydroxyl-containing (meth)acrylate such as a hydroxyalkyl (meth)acrylate (e.g., hydroxyethyl acrylate) with a polycarboxylic acid. The polyhydroxyl functional and polycarboxylic acid functional components can each have linear, branched, cycloaliphatic or aromatic structures and can be used individually or as mixtures.

Examples of suitable epoxy (meth)acrylates include the reaction products of acrylic or methacrylic acid or mixtures thereof with glycidyl ethers or esters.

Exemplary polyether (meth)acrylate oligomers include, but are not limited to, the condensation reaction products of acrylic or methacrylic acid or mixtures thereof with polyetherols which are polyether polyols (not including oligomers corresponding to the (meth)acrylate-functionalized oxetane/oxolane oligomers also employed as a component of the coating compositions of the present invention). Suitable polyetherols can be linear or branched substances containing ether bonds and terminal hydroxyl groups. Polyetherols can be prepared by ring opening polymerization of epoxides (e.g., ethylene oxide, 1,2-propylene oxide, butene oxide and combinations thereof) with a starter molecule. Suitable starter molecules include water, hydroxyl functional materials, polyester polyols and amines.

Urethane (meth)acrylates (sometimes also referred to as “polyurethane (meth)acrylates”) capable of being used in the coating compositions of the present invention include urethanes based on aliphatic and/or aromatic polyester polyols, polyether polyols and polycarbonate polyols and aliphatic and/or aromatic polyester diisocyanates and polyether diisocyanates capped with (meth)acrylate end-groups.

In various embodiments, the urethane (meth)acrylates may be prepared by reacting aliphatic and/or aromatic polyisocyanates (e.g., diisocyanates, triisocyanates) with OH group terminated polyester polyols (including aromatic, aliphatic and mixed aliphatic/aromatic polyester polyols), polyether polyols, polycarbonate polyols, polycaprolactone polyols, polydimethysiloxane polyols or polybutadiene polyols or combinations thereof to form isocyanate-functionalized oligomers which are then reacted with hydroxyl-functionalized (meth)acrylates such as hydroxyethyl (meth)acrylate or hydroxypropyl (meth)acrylate to provide terminal (meth)acrylate groups. For example, the urethane (meth)acrylates may contain two, three, four or more (meth)acrylate functional groups per molecule. Other orders of addition may also be practiced to prepare the polyurethane (meth)acrylate, as is known in the art. For example, the hydroxyl-functionalized (meth)acrylate may be first reacted with a polyisocyanate to obtain an isocyanate-functionalized (meth)acrylate, which may then be reacted with an OH group terminated polyester polyol, polyether polyol, polycarbonate polyol, polycaprolactone polyol, polydimethysiloxane polyol, polybutadiene polyol or a combination thereof. In yet another embodiment, a polyisocyanate may be first reacted with a polyol, including any of the aforementioned types of polyols, to obtain an isocyanate-functionalized polyol, which is thereafter reacted with a hydroxyl-functionalized (meth)acrylate to yield a polyurethane (meth)acrylate. Alternatively, all the components may be combined and reacted at the same time.

Any of the above-mentioned types of oligomers may be modified with amines or sulfides (e.g., thiols), following procedures known in the art. Such amine- and sulfide-modified oligomers may be prepared, for example, by reacting a relatively small portion (e.g., 2-15%) of the (meth)acrylate functional groups present in the base oligomer with an amine (e.g., a secondary amine) or a sulfide (e.g., a thiol), wherein the modifying compound adds to the carbon-carbon double bond of the (meth)acrylate in a Michael addition reaction.

In various embodiments of the invention, the coating composition does not contain any oligomer other than (meth)acrylate-functionalized oxetane/oxolane oligomer(s) or, if such other oligomer or oligomers is or are present it or they are present in relatively minor amounts relative to the weight of (meth)acrylate-functionalized oxetane/oxolane oligomer (e.g., not more than 50% by weight, not more than 40% by weight, not more than 30% by weight, not more than 10% by weight or not more than 5% by weight relative to the total weight of (meth)acrylate-functionalized oxetane/oxolane oligomer).

### Radiation-Curable (Meth)acrylate Monomers b)

Illustrative examples of suitable radiation-curable monomers include (meth)acrylated mono- and polyols (polyalcohols) and (meth)acrylated alkoxylated mono-alcohols and polyols. The mono-alcohols and polyols may be aliphatic (including one or more cycloaliphatic rings) or may contain one or more aromatic rings (as in the case of phenol or bisphenol A). “Alkoxylated” means that the base mono-alcohol or polyol has been reacted with one or more epoxides such as ethylene oxide and/or propylene oxide so as to introduce one or more ether moieties (e.g., —CH₂CH₂—O—) onto one or more hydroxyl groups of the mono-alcohol or polyol, prior to esterification to introduce one or more (meth)acrylate functional groups. For example, the amount of epoxide reacted with the mono-alcohol or polyol may be from about 1 to about 30 moles of epoxide per mole of mono-alcohol or polyol. Examples of suitable mono-alcohols include, but are not limited to, straight chain, branched and cyclic C₁-C₅₄ mono-alcohols (which may be primary, secondary or tertiary alcohols). For instance, the mono-alcohol may be a C₁-C₇ aliphatic mono-alcohol. In another embodiment, the mono-alcohol may be a C₈-C₂₄ aliphatic mono-alcohol (e.g., lauryl alcohol, stearyl alcohol). Examples of suitable polyols include organic compounds containing two, three, four or more hydroxyl groups per molecule such as glycols (diols), e.g., ethylene glycol, 1,2- or 1,3-propylene glycol or 1,2-, 1,3- or 1,4-butylene glycol, neopentyl glycol, trimethylolpropane, pentraerythritol, glycerol and the like.

Representative, but not limiting, examples of suitable radiation-curable (meth)acrylate monomers include: 1,3-butylene glycol di(meth)acrylate, 1,4-butanediol di(meth)acrylate, 1,6-hexanediol di(meth)acrylate, longer chain aliphatic di(meth)acrylates (such as those generally corresponding to the formula H₂C═CRC(═O)—O—(CH₂)ₘ—O—C(═O)CR′═CH₂, wherein R and R′ are independently H or methyl and m is an integer of 8 to 24, alkoxylated (e.g., ethoxylated, propoxylated) hexanediol di(meth)acrylates, alkoxylated (e.g., ethoxylated, propoxylated) neopentyl glycol di(meth)acrylates, dodecyl di(meth) acrylates, cyclohexane dimethanol di(meth)acrylates, diethylene glycol di(meth)acrylates, dipropylene glycol di(meth)acrylates, alkoxylated (e.g., ethoxylated, propoxylated) bisphenol A di(meth)acrylates, ethylene glycol di(meth)acrylates, neopentyl glycol di(meth)acrylates, tricyclodecane dimethanol diacrylates, triethylene glycol di(meth)acrylates, tetraethylene glycol di(meth)acrylates, tripropylene glycol di(meth)acrylates, d itrimethylol propane tetra(meth)acrylates, dipentaerythritol penta(meth)acrylates, alkoxylated (e.g., ethoxylated, propoxylated) pentaerythritol tetra(meth)acrylate, dipentaerythritol penta(meth)acrylates, pentaerythritol tetra(meth)acrylate, alkoxylated (e.g., ethoxylated, propoxylated) trimethylolpropane tri(meth)acrylates, alkoxylated (e.g., ethoxylated, propoxylated) glyceryl tri(meth)acrylates, trimethylolpropane tri(meth)acrylates, pentaerythritol tri(meth)acrylates, tris (2-hydroxy ethyl) isocyanurate tri(meth)acrylates, 2(2-ethoxyethoxy) ethyl (meth)acrylates, 2-phenoxyethyl (meth)acrylates, 3,3,5-trimethylcyclohexyl (meth)acrylates, alkoxylated lauryl (meth)acrylates, alkoxylated phenol (meth)acrylates, alkoxylated tetrahydrofurfuryl (meth)acrylates, caprolactone (meth)acrylates, cyclic trimethylolpropane formal (meth)acrylates, dicyclopentadienyl (meth)acrylates, diethylene glycol methyl ether (meth)acrylates, alkoxylated (e.g., ethoxylated, propoxylated) nonyl phenol (meth)acrylates, isobornyl (meth)acrylates, isodecyl (meth)acrylates, isooctyl (meth)acrylates, lauryl (meth)acrylates, methoxy polyethylene glycol (meth)acrylates, octyldecyl (meth)acrylates (also known as stearyl (meth)acrylates), tetrahydrofurfuryl (meth) acrylates, tridecyl (meth)acrylates, triethylene glycol ethyl ether (meth)acrylates, t-butyl cyclohexyl (meth)acrylates, dicyclopentadiene di(meth)acrylates, phenoxyethanol (meth)acrylates, octyl (meth)acrylates, decyl (meth)acrylates, dodecyl (meth)acrylates, tetradecyl (meth)acrylates, cetyl (meth)acrylates, hexadecyl (meth)acrylates, behenyl (meth)acrylates, diethylene glycol ethyl ether (meth)acrylates, diethylene glycol butyl ether (meth)acrylates, triethylene glycol methyl ether (meth)acrylates, dodecanediol di (meth)acrylates, dipentaerythritol penta/hexa(meth)acrylates, pentaerythritol tetra(meth)acrylates, alkoxylated (e.g., ethoxylated, propoxylated) pentaerythritol tetra(meth)acrylates, di-trimethylolpropane tetra(meth)acrylates, alkoxylated (e.g., ethoxylated, propoxylated) glyceryl tri(meth)acrylates and tris (2-hydroxy ethyl) isocyanurate tri(meth)acrylates and combinations thereof.

Generally speaking, in certain embodiments of the invention, it will be preferred to include in the coating composition one or more radiation-curable (meth)acrylate monomers that are mono- or di-functional (i.e., contain one or two (meth)acrylate groups per molecule) and which are aliphatic or alkoxylated. Examples of such (meth)acrylate monomers include propoxylated neopentyl glycol diacrylate, dodecanediol dimethacrylate, hexanediol diacrylate and lauryl acrylate.

According to certain embodiments of the invention, the coating composition is comprised of from about 1% to about 60% by weight or from about 10% to about 50% by weight or from about 20% to about 45% by weight in total of radiation-curable (meth)acrylate monomer (such amounts being based on the total weight of all components of the coating composition, other than any non-reactive solvent or water that may be present).

### Optional Carriers

In certain embodiments of the invention, the coating composition may contain water and/or one or more non-reactive solvents (e.g., organic solvents) which are capable of functioning as carriers for the other components of the composition.

However, in particularly advantageous embodiments of the present invention, the coating composition is formulated so as to contain little or no water and/or non-reactive solvent, e.g., not more than 10% or not more than 5% or not more than 1% or even 0% water and/or non-reactive solvent, based on the total weight of the coating composition. Such “high solids” compositions (which may be considered radiation-curable 100% solids coating compositions) may be formulated using various components, including for example low viscosity reactive diluents, which are selected so as to render the composition sufficiently low in viscosity, even without solvent or water being present, that the composition can be easily applied at a suitable application temperature to a substrate surface so as to form a relatively thin, uniform coating layer. The (meth)acrylate-functionalized oxetane/oxolane oligomer which is a component of the coating composition has been found to be helpful in formulating a relatively low viscosity curing composition. In various embodiments of the invention, the coating compositions described herein have a viscosity of less than 4000 cPs or less than 3500 cPs or less than 3000 cPs or less than 2500 cPs or less than 2000 cPs or less than 1500 cPs or, most preferably, less than 1000 cPa, as measured at 25° C. using a Brookfield viscometer, model DV-II, using a 27 spindle (with the spindle speed varying typically between 50 and 200 rpm, depending on viscosity).

### Photoinitiators d)

In certain embodiments of the invention, the coating compositions described herein include at least one photoinitiator and are curable with radiant energy (in particular, ultraviolet radiation). However, in other embodiments, the coating compositions do not contain photoinitiator and are cured using electron beam radiation.

If present in the coating composition, the photoinitiator or photoinitiators may be selected in accordance with the wavelength(s) of ultraviolet radiation emitted by the ultraviolet radiation source(s) being used to cure the coating composition. In one embodiment of the invention, at least one photoinitiator is present in the composition which absorbs energy at the wavelength emitted by a short wavelength ultraviolet radiation source and at least one photoinitiator is present in the composition which absorbs energy at the wavelength emitted by a long wavelength ultraviolet radiation source. In another embodiment, the composition contains a single photoinitiator which absorbs energy at both long and short wavelengths (which may be referred to as a “dual wavelength photoinitiator”). In yet another embodiment, the composition contains both a first photoinitiator which absorbs energy at a short wavelength but not at a long wavelength and a second photoinitiator which absorbs energy at a long wavelength but not at a short wavelength (each of which may be referred to as a “single wavelength photoinitiator”). In still another embodiment, a single photoinitiator is present which absorbs energy at either a short wavelength or a long wavelength. Other combinations are also possible, such as, for example, a dual wavelength photoinitiator in combination with one or more single wavelength photoinitiators, combinations of different dual wavelength photoinitiators and the like.

Accordingly, in one embodiment of the invention, a combination of photoinitiators is employed which possess different absorbance characteristics such that longer wavelength ultraviolet radiation can be used to excite or activate a photoinitiator or photoinitiators, while shorter wavelength ultraviolet radiation is used to excite one or more other photoinitiators which are present.

Suitable photoinitiators include, for example, alpha-hydroxy ketones, phenylglyoxylates, benzyldimethylketals, alpha-aminoketones, mono-acyl phosphines, bis-acyl phosphines, metallocenes, phosphine oxides, benzoin ethers and benzophenones and combinations thereof. Examples of suitable dual wavelength photoinitiators include, but are not limited to, 2-hydroxy-2-methyl-1-phenyl-1-propanone, benzyl dimethyl ketal and 1-hydroxycyclohexylphenyl ketone.

Suitable photoinitiators also include, but are not limited to, 2-methylanthraquinone, 2-ethylanthraquinone, 2-chloroanthraquinone, 2 benzyanthraquinone, 2-t-butylanthraquinone, 1,2-benzo-9,10-anthraquinone, benzyl, benzoin, benzoin methyl ether, benzoin ethyl ether, benzoin isopropyl ether, alpha-methylbenzoin, alpha-phenylbenzoin, Michler's ketone, benzophenone, 4,4′-bis-(diethylamino) benzophenone, acetophenone, 2,2 diethyloxyacetophenone, diethyloxyacetophenone, 2-isopropylthioxanthone, thioxanthone, diethyl thioxanthone, 1,5-acetonaphtlene, ethyl-p-dimethylaminobenzoate, benzil ketone, α-hydroxy keto, 2,4,6-trimethylbenzoyldiphenyl phosphine oxide, benzyl dimethyl ketal, benzil ketal (2,2-dimethoxy-1,2-diphenylethanone), 1-hydroxycyclohexyl phenyl ketone, 2-methyl-1-[4-(methylthio) phenyl]-2-morpholinopropanone-1, 2-hydroxy-2-methyl-1-phenyl-propanone, oligomeric α-hydroxy ketone, phenylbis(2,4,6-trimethylbenzoyl)phosphine oxide, ethyl-4-dimethylamino benzoate, ethyl(2,4,6-trimethylbenzoyl)phenyl phosphinate, anisoin, anthraquinone, anthraquinone-2-sulfonic acid, sodium salt monohydrate, (benzene) tricarbonylchromium, benzil, benzoin isobutyl ether, benzophenone/1-hydroxycyclohexyl phenyl ketone, 50/50 blend, 3,3′,4,4′-benzophenonetetracarboxylic dianhydride, 4-benzoylbiphenyl, 2-benzyl-2-(dimethylamino)-4′-morpholinobutyrophenone, 4,4′-bis(diethylamino)benzophenone, 4,4′-bis(dimethylamino)benzophenone, camphorquinone, 2-chlorothioxanthen-9-one, dibenzosuberenone, 4,4′-dihydroxybenzophenone, 2,2-dimethoxy-2-phenylacetophenone, 4-(dimethylamino)benzophenone, 4,4′-dimethylbenzil, 2,5-dimethylbenzophenone, 3,4-dimethylbenzophenone, diphenyl(2,4,6-trimethylbenzoyl)phosphine oxide /2-hydroxy-2-methylpropiophenone, 50/50 blend, 4′-ethoxyacetophenone, 2,4,6-trimethylbenzoyldiphenylphophine oxide, phenyl bis(2,4,6-trimethyl benzoyl)phosphine oxide, ferrocene, 3′-hydroxyacetophenone, 4′-hydroxyacetophenone, 3-hydroxybenzophenone, 4-hydroxybenzophenone, 1-hydroxycyclohexyl phenyl ketone, 2-hydroxy-2-methylpropiophenone, 2-methylbenzophenone, 3-methylbenzophenone, mixtures of benzophenone and methylbenzophenones, methybenzoylformate, 2-methyl-4′-(methylthio)-2-morpholinopropiophenone, phenanthrenequinone, 4′-phenoxyacetophenone, (cumene)cyclopentadienyl iron(ii) hexafluorophosphate, 9,10-diethoxy and 9,10-dibutoxyanthracene, 2-ethyl-9,10-dimethoxyanthracene, thioxanthen-9-one, oligo [2-hydroxy-2-methyl-1-[4-(1-methylvinyl)phenyl] propanone] and combinations thereof.

The amount of photoinitiator is not considered to be critical, but may be varied as may be appropriate depending upon the photoinitiator(s) selected, the amounts of (meth)acrylate-functionalized oxetane/oxolane oligomer(s) and other radiation-curable compound(s) present in the coating composition, the radiation source and the radiation conditions used, among other factors. Typically, however, the amount of photoinitiator may be from 0.05% to 10% by weight, based on the total weight of the coating composition, where the coating composition is to be cured using ultraviolet radiation. In certain embodiments, the coating composition is comprised of from 0.1 to 10 percent by weight photoinitiator (which may be a single photoinitiator, such as a dual wavelength photoinitiator or a combination of photoinitiators, such as a short wavelength photoinitiator and a long wavelength photoinitiator).

### Free Radical Initiators

In other embodiments, the coating compositions described herein include at least one free radical initiator that decomposes when heated or in the presence of an accelerator and are curable chemically (i.e., without having to expose the coating composition to radiation). The at least one free radical initiator that decomposes when heated or in the presence of an accelerator may, for example, comprise a peroxide or azo compound. Suitable peroxides for this purpose may include any compound, in particular any organic compound, that contains at least one peroxy (—O—O—) moiety, such as, for example, dialkyl, diaryl and aryl/alkyl peroxides, hydroperoxides, percarbonates, peresters, peracids, acyl peroxides and the like. The at least one accelerator may comprise, for example, at least one tertiary amine and/or one or more other reducing agents based on metal salts (such as, for example, carboxylate salts of transition metals such as iron, cobalt, manganese, vanadium and the like and combinations thereof). The accelerator(s) may be selected so as to promote the decomposition of the free radical initiator at room or ambient temperature to generate active free radical species, such that curing of the coating composition is achieved without having to heat or bake the coating composition. In other embodiments, no accelerator is present and the coating composition is heated to a temperature effective to cause decomposition of the free radical initiator and to generate free radical species which initiate curing of the coating composition.

### Surface Conditioner Additives c)

The coating compositions of the present invention comprise at least one surface conditioner additive c) selected from the group consisting of slip additives and particulate surface modification agents. These types of additives, which function to alter the haptic properties of the surface of the coating composition once cured, are discussed in more detail below. It is noted, however, that certain types of substances, such as waxes, may act as both slip additives and particulate surface modification agents.

In one embodiment, the coating composition is comprised of both at least one slip additive and at least one particulate surface modification agent. In particular, where the coating composition is comprised of at least one inorganic substance such as silica as a particulate surface modification agent, it is additionally comprised of at least one slip additive, such as, for example, at least one polysiloxane slip additive.

In addition to improving the haptic or tactile qualities of a coating composition, when the coating composition is cured as a layer on the surface of a substrate, the surface conditioner additive(s) may enhance one or more other attributes of the cured coating composition, such as anti-blocking properties, abrasion resistance, water repellency and the like.

The total amount of surface conditioner additive present in the coating composition may vary significantly, depending upon the type(s) of surface conditioner additive selected for use. Typically, however, the coating composition may comprise from about 0.2 to about 40% by weight in total of surface conditioner additive.

### Slip Additives

The coating compositions utilized in the present invention may comprise at least one slip additive. Any of the slip additives known in the coatings art or combinations of such slip additives, may be employed. A slip additive is a component which functions to improve the “slip” of a surface. “Slip” is the relative movement between two objects that are in contact with each other. If an object is moved along a surface, there is a resistance acting in a direction opposite the movement. The resisting force is also called frictional force, wherein the friction results from the unevenness of the two surfaces in contact. The slip additive, which may or may not dissolve in or become solubilized in the coating composition before or after curing, serves to reduce the coefficient of friction of the cured coating obtained from the coating composition.

Suitable types of slip additives for use in the present invention include both reactive and non-reactive slip additives, such as polysiloxanes, natural and synthetic waxes and fluoropolymers. The term “polysiloxane” includes oligomeric and polymeric substances based on silicone chemistry, including both homopolymeric and copolymeric materials. Exemplary types of suitable polysiloxanes include polydialkylsiloxanes (e.g., polydimethylsiloxanes), silicone polyether copolymers (sometimes also referred to as polyoxyalkylenesiloxane copolymers, polyoxyalkylene methylalkylsiloxane copolymers or polysiloxane/polyether copolymers; the polyoxyalkylene portions of such copolymers may be based on ethylene oxide and/or propylene oxide, for example), polyether-modified silicones and silicone acrylates (e.g., silicone-modified polyacrylates). Suitable waxes include, for example, paraffin-based waxes and polyolefin (e.g., polypropylene and polyethylene)-based waxes. As recognized in the art, a “wax” is a naturally occurring or synthetic material which is solid at 20° C. (varying in consistency from soft and plastic to hard and brittle), has a melting point of at least 40° C. without decomposing and has a relatively low viscosity at temperatures slightly above its melting point and at such temperatures is non-stringing and capable of producing droplets (thus distinguishing waxes from high molecular weight polymers). Generally speaking, a wax will be relatively low in molecular weight (Mₙ<10,000). Suitable fluoropolymer slip additives include, for example, homopolymers and copolymers of tetrafluoroethylene, hexafluoropropylene and vinylidene fluoride, as well as perfluoroalkyl acrylates (e.g., perfluoro octyl acrylate) and perfluoropolyether acrylates (which are considered reactive slip additives, since they are capable of undergoing a polymerization or curing reaction with other radiation-curable compounds present in the coating composition) and similar substances. Fatty acid amides may also be utilized as slip additives, in particular saturated fatty acid amides. Suitable slip additives are available from commercial sources, including for example the slip additives sold by Evonik under the brand name TEGO® and the slip additives sold by BYK under various brand names.

In one embodiment of the invention, at least one slip additive is present in the coating composition which comprises at least one radiation-curable double bond (which may be in the form, for example, of a (meth)acrylate group. If such a reactive slip additive is present, it is taken into account when calculating the total amount of “other radiation-curable compound(s)” in the coating composition.

The amount of slip additive present in the coating composition will depend upon a number of factors, including the identities of the slip additive(s) and other components employed in the coating composition and the particular haptic qualities desired in the cured coating obtained from the coating composition, but typically will be at least about 0.05 percent by weight based on the total weight of the coating composition. In certain embodiments, the coating composition is comprised of from 0.2 to 20 percent by weight slip additive, with higher concentrations of slip additive generally being preferred if the slip additive is a reactive slip additive.

### Particulate Surface Modification Agents

The coating compositions of the present invention may contain one or more types of particulate surface modification agents, which are in particle form and generally do not dissolve in or become solubilized in the coating compositions both before and after the compositions are cured (i.e., they remain as discrete particles in the cured coating composition). Typically, such particulate surface modification agents are non-reactive, i.e., they do not react upon curing of the coating composition when the coating composition is exposed to ultraviolet radiation. Suitable particulate surface modification agents include those substances referred to in the coatings art as “matting agents”, “flattening agents” or “flatting agents”. Typically, the particulate surface modification agent will have an average particle size within the range of from about 0.02 microns to about 50 microns. Suitable particulate surface modification agents include both organic and inorganic substances, as well as combinations of organic and inorganic substances. Oligomeric and polymeric substances (e.g., waxes, thermoplastics as well as thermosets and crosslinked polymers) are examples of organic substances useful as particulate surface modification agents, particularly in the form of wax particles or polymer beads. Exemplary oligomers and polymers include, but are not limited to, poly(meth)acrylates (acrylic resins), polyurethanes, polyamides, polyolefins (e.g., polyethylenes, polypropylenes), polysilicones (e.g., silicone elastomers), fluoropolymers such as polytetrafluoroethylenes (PTFEs) and combinations thereof. The particulate surface modification agent may be in the form of a wax, e.g., a wax dispersion. Inorganic substances useful as particulate surface modification agents include silicas (including fumed or thermal silicas, silicates such as aluminum silicates as well as silica-containing substances such as diatomaceous earth, clays, talc and the like), metal hydroxides, metal oxides (e.g., alumina), inorganic carbonates such as calcium carbonate, calcium and zinc salts of fatty acids such as stearic acid and the like as well as organo-modified derivatives thereof (such as polymer-treated thermal silicas or polysiloxane-coated fumed silicas). When a silica is used as a particulate surface modification agent, it can be used in various forms including, but not limited to, amorphous, aerogel, diatomaceous, hydrogel, fumed, micronized, wax-treated and mixtures thereof. Silicas suitable for use as particulate surface modification agents are available from commercial sources, including for example the silicas sold by Evonik under the brand name ACEMATT®. In various embodiments, the particulate surface modification agents may be in the form of spherical beads or hollow beads.

The amount of particulate surface modification agent in the coating composition may vary depending upon the type(s) of particulate surface modification agent(s) employed as well as the haptic characteristics desired in the cured coating obtained from the coating composition. Typically, however, amounts of particulate surface modification agent within the range of from about 0.2 to about 30 percent by weight, based on the total weight of the coating composition, are suitable.

### Other Additives

The coating compositions of the present invention may optionally contain one or more additives instead of or in addition to the above-mentioned ingredients. Such additives include, but are not limited to, antioxidants, ultraviolet absorbers, photostabilizers, foam inhibitors, flow or leveling agents, colorants, pigments, dispersants (wetting agents) or other various additives, including any of the additives conventionally utilized in the coating art.

### Exemplary Formulations

In certain embodiments of the invention, the coating composition may comprise, consist essentially of or consist of the following components:
i) (meth)acrylate-functionalized oxetane/oxolane oligomer(s);
ii) radiation-curable compound(s) other than (meth)acrylate-functionalized oxetane/oxolane oligomer(s);
iii) optionally, dispersant(s);
iv) particulate surface modification agent(s);
v) optionally, photoinitiator(s); and
vi) slip additive(s).

In certain embodiments, the coating composition is comprised of 30 to 70% by weight i), 20 to 70% by weight ii), 0-5% by weight iii), 2-20% by weight iv), 0-20% by weight v) and 0.1-20% by weight vi), based on the total weight of i)-vi). In other embodiments, the coating composition is comprised of 35-65% by weight i), 35 to 45% by weight ii), 0.1-2% by weight iii), 4-12% by weight iv), 0-10% by weight v) and 0.5-3% by weight vi), based on the total weight of i)-vi).

### Substrates

A substrate to which the above-described coating composition may be applied and cured in accordance with the present invention may be any commercially relevant substrate, such as a high surface energy substrate or a low surface energy substrate, such as a metal substrate or plastic substrate, respectively. The substrates may comprise steel or other metal, paper, cardboard, glass or other type of ceramic, a thermoplastic such as a polyolefin, polycarbonate, acrylonitrile butadiene styrene or blends thereof, composites, wood, leather and combinations thereof.

### Exemplary Methods of Applying and Curing the Coating Compositions

In various embodiments of the present invention, the coating compositions described herein are curable by techniques selected from the group consisting of radiation curing (UV radiation or electron beam curing), electron beam curing, chemical curing (using a free radical initiator that decomposes when heated or in the presence of an accelerator, e.g., peroxide curing), heat curing or combinations thereof.

In various embodiments, a method of coating a substrate with the coating compositions described herein may comprise, consist of, or consist essentially of applying the composition to a substrate (wherein, for example, the applied composition is in the form of a layer on a surface of a substrate) and curing the composition by exposing the composition to radiation (e.g., ultraviolet radiation, electron beam radiation). In one embodiment, the coating composition preferably contains at least one photoinitiator and is cured using ultraviolet radiation from a single source. In another embodiment, the curing comprises curing by exposing the coating composition (preferably containing at least one photoinitiator) to ultraviolet radiation of at least two different wavelengths (including long wavelength ultraviolet radiation, followed by short wavelength ultraviolet radiation).

In various embodiments of the invention, the coating compositions may be applied to a substrate by a method selected from the group consisting of spraying, knife coating, roller coating, casting, drum coating, dipping and combinations thereof. A plurality of layers of a coating composition in accordance with the present invention may be applied to a substrate surface; the plurality of layers may be simultaneously cured or each layer may be successively cured before application of an additional layer of coating composition.

The thickness of the coating prepared from the coating compositions of the present invention may be varied as may be desired for a particular end use application, but typically will be in the range of from 4 microns to 200 microns. In one embodiment, the cured coating has a thickness of about 10 to about 75 microns.

To cure a layer of coating composition, the coating composition layer may be exposed to a source of electron beam radiation, a source of ultraviolet radiation of appropriate wavelength(s) or, in a preferred embodiment, successively exposed to sources of ultraviolet radiation of different wavelength. For example, it may be advantageous, depending upon the components of the coating composition and the properties, in particular the haptic properties, desired in the cured coating, to first employ long wavelength ultraviolet radiation, followed by (either immediately or after a period of time) short wavelength ultraviolet radiation. The long wavelength UV radiation may, for example, be UV-A radiation or have a wavelength of from 300 to 420 nm or 320 to 400 nm. The long wavelength UV radiation may be supplied by one or more lamps selected from the group consisting of D bulb mercury lamps, V bulb mercury lamps and LED lamps. The short wavelength UV radiation may be UV-C radiation or have a wavelength of from 220 to 280 nm or 230 to 270 nm and may be supplied by one or more lamps selected from the group consisting of mercury arc lamps and H bulb lamps.

Generally speaking, light sources suitable for ultraviolet (UV) curing include arc lamps, such as carbon arc lamps, xenon arc lamps, mercury vapor lamps, tungsten halide lamps, lasers, sunlamps and fluorescent lamps with ultra-violet light emitting phosphors. Commercial UV/Visible light sources with varied spectral output in the range of 250-450 nm may be used for curing purposes, wherein wavelength selection can be achieved with the use of optical bandpass or longpass filters.

Regardless of the light source, the emission spectrum of the lamp(s) must overlap the absorbance spectrum of the photoinitiator. Two aspects of the photoinitator absorbance spectrum need to be considered: the wavelength absorbed and the strength of absorption (molar extinction coefficient). For example, the photoinitiators oligo[2-hydroxy-2-methyl-1-[4-methylvinyl) phenyl]propanone] and diphenyl (2,4,6-trimethylbenzoyl) phosphine oxide have absorbance peaks at 225-290 nm (which is in the short UV wavelength range) and 320-380 nm (which is in the long UV wavelength range).

A layer of a coating composition in accordance with the invention may, for example, be applied to a substrate surface to provide a coated substrate, partially cured by exposure of the uncured coating composition layer to a source of long wavelength ultraviolet radiation, then fully cured by exposure of the partially cured coating composition layer to a source of short wavelength ultraviolet radiation. Typical exposure times may range, for example, from less than 1 second up to several minutes. Generally speaking, UV curable coatings require a dose or radiant energy density of between 0.5 to 3.0 Joules/cm² to achieve full cure at reasonable line speeds.

Any of the conventional electron beam curing techniques known in the coating art may be adapted for use with the coating compositions of the present invention. For example, scanning electron beam, continuous electron beam and continuous compact electron beam methods may be utilized. The electron beam curing may be conducted under conditions effective to achieve a high (e.g., >90%, >95% or >99%) conversion of the radiation-curable compounds present in the coating composition. Curing may be conducted so as to provide an electron beam absorbed dose of from about 1 kGy to about 40 kGy, for example. Typically, electron beam voltages of not greater than 300 kV are employed.

### Exemplary End Use Applications

In various embodiments of the invention, the coating compositions described herein may be used to provide coatings and/or films, such as coatings and/or films for automobiles and other motor vehicles (e.g., as coatings on armrests, dashboards, seating, switches, controls and other interior components), aeronautic components, small appliances, packaging (e.g., cosmetics packaging), printing enhancements (inks), top coats (over varnishes) over inks in graphic arts applications, coatings on leathers and synthetic leathers and/or consumer electronics. For example, the coating compositions may be cured prior to use as coatings and/or films for such end use applications.

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

In some embodiments, the invention herein can be construed as excluding any element or process step that does not materially affect the basic and novel characteristics of the curable composition or process. Additionally, in some embodiments, the invention can be construed as excluding any element or process step not specified herein.

Although the invention is illustrated and described herein with reference to specific embodiments, the invention is not intended to be limited to the details shown. Rather, various modifications may be made in the details within the scope and range of equivalents of the claims and without departing from the invention.

### EXAMPLES

### Examples 1, 1B and 2

Three different coating compositions were prepared, in accordance with the following formulations (Tables 1-3). The “silica” used in each composition was a polymer-treated thermal silica (alternatively described as a polysiloxane-coated fumed silica). The “slip additive” used in each composition was a polyether siloxane copolymer (alternatively described as a polyether siloxane).

### Example 1

TABLE 1

| Component | Mass (g) | Weight % |
|---|---|---|
| Diacrylate-Functionalized | 24.00 | 52.46 |
| Polytetramethylene Ether | | |
| (Mₙ = ca. 650 g/mol) | | |
| Propoxylated Neopentyl | 16.00 | 34.97 |
| Glycol Diacrylate | | |
| Dispersant (structured acrylic | 0.35 | 0.77 |
| copolymer) | | |
| Silica | 3.40 | 7.43 |
| 2-Hydroxy-2-methyl-1-phenyl- | 2.00 | 4.37 |
| 1-propanone | | |
| Total | 45.75 | 100.00 |

### Example 1B

TABLE 2

| Component | Mass (g) | Weight % |
|---|---|---|
| Diacrylate-Functionalized | 24.00 | 51.68 |
| Polytetramethylene Ether | | |
| (Mₙ = ca. 650 g/mol) | | |
| Propoxylated Neopentyl | 16.00 | 34.45 |
| Glycol Diacrylate | | |
| Dispersant (structured acrylic | 0.35 | 0.76 |
| copolymer) | | |
| Silica | 3.40 | 7.32 |
| 2-Hydroxy-2-methyl-1-phenyl- | 2.00 | 4.31 |
| 1-propanone | | |
| Slip Additive | 0.69 | 1.48 |
| Total | 46.44 | 100.00 |

### Example 2

TABLE 3

| Component | Mass (g) | Weight % |
|---|---|---|
| Diacrylate-Functionalized | 39.00 | 51.22 |
| Polytetramethylene Ether | | |
| (Mₙ = ca. 650 g/mol) | | |
| Propoxylated Neopentyl Glycol | 26.00 | 34.15 |
| Diacrylate | | |
| Dispersant (structured acrylic | 0.57 | 0.75 |
| copolymer) | | |
| Silica | 5.53 | 7.26 |
| Diphenyl(2,4,6- | 1.95 | 2.56 |
| trimethylbenzoyl)phosphine oxide | | |
| 70:30 (w/w) blend of oligo[2- | 1.95 | 2.56 |
| hydroxy-2-methyl-1-[4-(1- | | |
| methylvinyl)phenyl]propanone] and | | |
| 2-hydroxy-2-methyl-1-phenyl-1- | | |
| propanone | | |
| Slip Additive | 1.14 | 1.50 |
| Total | 76.14 | 100.00 |

The aforementioned formulations were drawn down on substrates as 1 mil thickness coatings and photocured using different conditions, as summarized in the following Table 4. The results obtained for the cured coatings are also described in the table.

TABLE 4

| Formulation | | | |
|---|---|---|---|
| Example | Cure Conditions | Feel | Gloss |
| 1 | 2 Mercury arc lamps, 400 W/in, | Not Soft | 31.7 |
| | 50 fpm | | |
| 1B | 2 Mercury arc lamps, 400 W/in, | Not Soft | 33.9 |
| | 50 fpm | | |
| 2 | V lamp 600 W/in + 2 passes under 2 | Velvety | 10.4 |
| | Mercury arc lamps, 50 fpm | | |
| 2 | V lamp 400 W/in + 2 passes under 2 | Velvety | 8.8 |
| | Mercury arc lamps, 50 fpm | | |
| 2 | 395 nm LED 12 W/in + 2 passes | Velvety | 8.2 |
| | under 2 Mercury arc lamps, 50 fpm | | |
| 2 | 395 nm LED 6 W/in + 2 passes | Velvety | 5.9 |
| | under 2 Mercury arc lamps, 50 fpm | | |

### Example 3 (Comparative)

The following formulation (Table 5) was prepared as a coating composition.

TABLE 5
(Example 3)

| Component | Mass (g) | Weight % |
|---|---|---|
| Acrylate Oligomer (Isocyanurate | 15.76 | 47.44 |
| Derivative) | | |
| Lauryl Acrylate | 7.88 | 23.72 |
| Propoxylated Neopentyl Glycol | 5.25 | 15.81 |
| Diacrylate | | |
| Dispersant | 0.22 | 0.67 |
| Silica | 2.17 | 6.52 |
| 2-Hydroxy-2-methyl-1-phenyl-1- | 1.44 | 4.35 |
| propanone | | |
| Slip Additive (Polyether Siloxane | 0.49 | 1.48 |
| Copolymer) | | |
| Total | 33.22 | 100.00 |

The coating composition of Example 3 was drawn down to a thickness of 3 mil on a substrate and photocured using the conditions shown in Table 6.

TABLE 6

| Formulation | | | |
|---|---|---|---|
| Example | Cure Conditions | Feel | Gloss |
| 3 | 2 Mercury arc lamps, 400 W/in, | Not Soft | 38.2 |
| | 50 fpm | | |
| 3 | V lamp 600 W/in + H lamp 600 W/in, | Velvety/ | 6.7 |
| | 50 fpm | Silky | |

### Example 4

A coating composition was prepared based on the following formulation (Table 7):

TABLE 7
(Example 4)

| Component | Mass (g) | Weight % |
|---|---|---|
| Diacrylate-Functionalized | 12.00 | 50.35 |
| Polytetramethylene Ether | | |
| (Mₙ = ca. 650 g/mol) | | |
| Propoxylated Neopentyl Glycol | 8.00 | 33.57 |
| Diacrylate | | |
| Dispersant (structured acrylic | 0.18 | 0.74 |
| copolymer) | | |
| Silica | 1.70 | 7.13 |
| 1-Hydroxy-cyclohexyl-phenyl- | 0.90 | 3.78 |
| ketone | | |
| 2,4,6-Trimethylbenzoyl-diphenyl | 0.30 | 1.26 |
| Phosphine Oxide | | |
| Mixture of Benzophenones and | 0.40 | 1.68 |
| Methylbenzophenones | | |
| Slip Additive (Polyether Siloxane | 0.36 | 1.50 |
| Copolymer) | | |
| Total | 23.83 | 100.00 |

### Example 5

A coating composition was prepared based on the following formulation (Table 8):

TABLE 8
(Example 5)

| Component | Mass (g) | Weight % |
|---|---|---|
| Diacrylate-Functionalized | 12.00 | 51.67 |
| Polytetramethylene Ether | | |
| (Mₙ = ca. 650 g/mol) | | |
| Propoxylated Neopentyl Glycol | 8.00 | 34.45 |
| Diacrylate | | |
| Dispersant (structured acrylic copolymer) | 0.18 | 0.76 |
| Silica | 1.7 | 7.32 |
| 50:50 Blend of 1-Hydroxy-cyclohexyl- | 1 | 4.31 |
| phenyl-ketone and Benzophenone | | |
| Slip Additive (Polyether Siloxane | 0.35 | 1.50 |
| Copolymer) | | |
| Total | 23.22 | 100.00 |

The coating compositions of Examples 1B, 2, 4 and 5 were drawn down to a thickness of 3 mil on a substrate and photocured using the conditions described in the following Table 9.

TABLE 9

| Formulation | | | |
|---|---|---|---|
| Example | Cure Conditions | Feel | Gloss |
| 1B | V lamp 600 W/in + H lamp | Velvety | 1.4 |
| | 600 W/in, 50 fpm | | |
| 4 | V lamp 600 W/in + H lamp | Velvety | 3.2 |
| | 600 W/in, 50 fpm | | |
| 2 | V lamp 600 W/in + H lamp | Velvety/Rubbery | 1.4 |
| | 600 W/in, 50 fpm | | |
| 5 | V lamp 600 W/in + H lamp | Velvety | 2.0 |
| | 600 W/in, 50 fpm | | |

### Examples 6-8

Coating compositions were prepared based on the formulations described in Tables 10-12.

TABLE 10
(Example 6)

| Component | Mass (g) | Weight % |
|---|---|---|
| Diacrylate-Functionalized | 24.00 | 51.67 |
| Polytetramethylene Ether | | |
| (Mₙ = ca. 650 g/mol) | | |
| Long Chain Aliphatic | 16.00 | 34.44 |
| Diacrylate | | |
| Dispersant (structured acrylic | 0.35 | 0.76 |
| copolymer) | | |
| Silica | 3.40 | 7.32 |
| 2-Hydroxy-2-methyl-1-phenyl- | 2.00 | 4.31 |
| 1-propanone | | |
| Slip Additive (Polyether | 0.70 | 1.51 |
| Siloxane Copolymer) | | |
| Total | 46.45 | 100.00 |

TABLE 11
(Example 7)

| | Mass | |
|---|---|---|
| Component | (g) | Weight % |
| Polyester Acrylate Oligomer (based | 24.00 | 50.39 |
| on caprolactone) | | |
| Propoxylated Neopentyl Glycol | 16.00 | 33.59 |
| Diacrylate | | |
| Dispersant (structured acrylic | 0.35 | 0.74 |
| copolymer) | | |
| Silica | 3.40 | 7.14 |
| 1-Hydroxy-cyclohexyl-phenyl-ketone | 1.80 | 3.78 |
| 2,4,6-Trimethylbenzoyl-diphenyl- | 0.60 | 1.26 |
| phosphine Oxide | | |
| Mixture of Benzophenone and | 0.80 | 1.68 |
| Methylbenzophenones | | |
| Slip Additive (Polyether Siloxane | 0.68 | 1.43 |
| Copolymer) | | |
| Total | 47.63 | 100.00 |

TABLE 12
(Example 8)

| Component | Mass (g) | Weight % |
|---|---|---|
| Alkoxylated Trimethylolpropane | 24.00 | 50.39 |
| Triacrylate | | |
| Propoxylated Neopentyl Glycol | 16.00 | 33.59 |
| Diacrylate | | |
| Dispersant (structured acrylic | 0.35 | 0.74 |
| copolymer) | | |
| Silica | 3.40 | 7.14 |
| 1-Hydroxy-cyclohexyl-phenyl-ketone | 1.80 | 3.78 |
| 2,4,6-Trimethylbenzoyl-diphenyl- | 0.60 | 1.26 |
| phosphine Oxide | | |
| Mixture of Benzophenone and | 0.80 | 1.68 |
| Methylbenzophenones | | |
| Slip Additive (Polyether Siloxane | 0.68 | 1.43 |
| Copolymer) | | |
| Total | 47.63 | 100.00 |

The coating compositions of Examples 1B, 3 and 6-8 were drawn down to a thickness of 3 mil on a substrate and photocured using first a V lamp (600 W/in) followed by an H lamp (600 W/in) at 50 fpm.

The coating compositions of Examples 1B, 3 and 6-8, when uncured, had the viscosities at 25° C. as shown in Table 13.

TABLE 13

| Example | Viscosity, mPa · s (cP) at 25° C. |
|---|---|
| 1B | 790 |
| 6 | 2960 |
| 7 | 2083 |
| 8 | 1410 |
| 3 | 13,820 |

Table 14 shows various attributes of the cured coatings obtained using the coating compositions of Examples 1B, 3 and 6-8.

TABLE 14

| | | Pencil | | MEK | |
|---|---|---|---|---|---|
| Example | Feel | Hardness | Gloss | Resistance | Quality |
| 1B | Velvety | 4B | 8.4 | 85 | 4 |
| 6 | Rubbery/Velvety | 3B | 6.4 | 200+ | 4.5 |
| 7 | Silky | 6H | 1.6 | 200+ | 3.5 |
| 8 | Velvety | HB | 5.6 | 53 | 2.5 |
| 3 | Velvety | 4B | 3.1 | 86 | 4.5 |

The properties reported for the Examples were determined using a number of known techniques. Pencil hardness values were determined in accordance with ASTM D3363-05. MEK (mar) resistance was determined in accordance with ASTM D5402-06. Viscosities were measured with a Brookfield viscometer, model DV-II, at 25° C. using a 27 spindle and speed was varied depending on viscosity, typically between 50 and 200 rpm. Gloss was measured with a BYK micro-tri-gloss meter at 60 degree angle.

The “Feel” and “Quality” ratings reported in Table 14 were determined in accordance with the following procedures: the cured coatings of the Examples were compared to commercially available two-part urethane soft feel coatings and were rated by a relatively large pool of experienced observers on type of feel (rubbery, velvety, silky) and softness (1=no soft feel, 5=best soft feel).

1. A coating composition useful for forming a soft touch coating on a surface of a substrate, wherein the coating composition comprises:
a) at least one (meth)acrylate-functionalized oxetane/oxolane oligomer selected from the group consisting of (meth)acrylate-functionalized polytrimethylene ethers, (meth)acrylate-functionalized polytetramethylene ethers, (meth)acrylate-functionalized poly-co-tetramethylene-trimethylene ethers;
b) at least one radiation-curable compound other than (meth)acrylate-functionalized oxetane/oxolane oligomer; and
c) at least one surface conditioner additive selected from the group consisting of slip additives and particulate surface modification agents
d) optionally, at least one photoinitiator, said photoinitiator d) being either one photoinitiator which absorbs both long and short wavelength ultraviolet radiation or said photoinitiator d) is comprising a first photoinitiator which absorbs long wavelength ultraviolet radiation and a second photoinitiator which absorbs short wavelength ultraviolet radiation.

2. The coating composition of claim 1, wherein the coating composition comprises at least one photoinitiator d).

3. The coating composition of claim 1, wherein the at least one (meth)acrylate-functionalized oxetane/oxolane oligomer a) is a di(meth)acrylate-functionalized polytetramethylene ether.

4. The coating composition of claim 1, wherein the at least one (meth)acrylate-functionalized polytetramethylene ether is an acrylate-functionalized polytetramethylene ether.

5. The coating composition of claim 1, wherein the at least one (meth)acrylate-functionalized oxetane/oxolane oligomer a) corresponds to formula (I):
H₂C═C(R)C(═O)—O—[(CH₂)ₓ—O]ₙC(═O)C(R′)═CH₂ (I)
wherein R and R′ are independently selected from the group consisting of hydrogen and methyl, x is 3 or 4 and n is an integer of from 2 to 100.

6. The coating composition of claim 5, wherein R and R′ are both hydrogen.

7. The coating composition of claim 5, wherein the at least one (meth)acrylate-functionalized oxetane/oxolane oligomer is a mixture of (meth)acrylate-functionalized polytetramethylene ethers of formula (I) wherein n is from about 3 to about 42 on average.

8. The coating composition of claim 1, wherein the at least one (meth)acrylate-functionalized oxetane/oxolane oligomer is from about 40% to about 95% by weight of the total amount of (meth)acrylate-functionalized oxetane/oxolane oligomer(s) a) and radiation-curable compound(s) b) other than (meth)acrylate-functionalized oxetane/oxolane oligomer in the coating composition.

9. The coating composition of claim 1, wherein the at least one surface conditioner additive c) comprises at least one slip additive selected from the group consisting of polysiloxanes, natural and synthetic waxes and fluoropolymers, wherein the slip additive may optionally comprise at least one radiation-curable double bond.

10. The coating composition of claim 1, wherein the at least one surface conditioner additive c) comprises at least one polysiloxane selected from the group consisting of silicone polyether copolymers and silicone acrylates.

11. The coating composition of claim 1, wherein the coating composition is comprised of from 0.2 to 20 percent by weight of slip additive.

12. The coating composition of claim 1, wherein the at least one radiation-curable compound b) other than (meth)acrylate-functionalized oxetane/oxolane oligomer, comprises at least one (meth)acrylate-functionalized monomer or oligomer selected from the group consisting of (meth)acrylate esters of aliphatic mono-alcohols, (meth)acrylate esters of alkoxylated aliphatic mono-alcohols, (meth)acrylate esters of aliphatic polyols, (meth)acrylate esters of alkoxylated aliphatic polyols. (meth)acrylate esters of aromatic alcohols, (meth)acrylate esters of alkoxylated aromatic alcohols, epoxy (meth)acrylates, polyether (meth)acrylates, urethane (meth)acrylates, polyester (meth)acrylates and amine- and sulfide-modified derivatives thereof and combinations thereof.

13. The coating composition of claim 1, wherein the at least one radiation-curable compound b) other than (meth)acrylate-functionalized oxetane/oxolane oligomer, comprises at least one (meth)acrylate-functionalized substance selected from the group consisting of di(meth)acrylate-functionalized aliphatic diols which includes di(meth)acrylate-functionalized alkoxylated aliphatic diols.

14. The coating composition of claim 1, wherein the at least one radiation-curable compound b) other than (meth)acrylate-functionalized oxetane/oxolane oligomer, comprises at least one (meth)acrylate-functionalized substance selected from the group consisting of di(meth)acrylate-functionalized propoxylated neopentyl glycol and di(meth)acrylate-functionalized C₈-C₂₂ aliphatic diols.

15. The coating composition of claim 1, wherein the coating composition is comprised of 50 to 99 percent by weight in total of (meth)acrylate-functionalized oxolane/oxetane oligomer a) and radiation-curable compound b).

16. The coating composition of claim 1, wherein the at least one surface conditioner additive c) comprises at least one particulate surface modification agent selected from the group consisting of silicas, polymer beads and wax particles.

17. The coating composition of claim 1, wherein the coating composition is comprised of from 0.2 to 30 percent by weight particulate surface modification agent.

18. The coating composition of claim 1, wherein the coating composition comprises at least one slip additive and at least one particulate surface modification agent.

19. The coating composition of claim 1, wherein the coating composition comprises at least one slip additive and at least one silica as a particulate surface modification agent.

20. The coating composition of claim 1, wherein the coating composition comprises at least one polysiloxane as a slip additive and at least one silica as a particulate surface modification agent.

21. The coating composition of claim 1, wherein the coating composition comprises at least one photoinitiator d) and wherein the at least one photoinitiator comprises at least one photoinitiator selected from the group consisting of alpha-hydroxy ketones, phenylglyoxylates, benzyldimethylketals, alpha-aminoketones, mono-acyl phosphines, bis-acyl phosphines, metallocenes, phosphine oxides, benzoin ethers and benzophenones and combinations thereof.

22. The coating composition of claim 1, wherein the coating composition comprises a single photoinitiator d) which is capable of absorption of both short wavelength ultraviolet radiation and long wavelength ultraviolet radiation.

23. The coating composition of claim 1, wherein the coating composition is comprised of a first photoinitiator which is capable of absorption of short wavelength ultraviolet radiation and a second photoinitiator which is capable of absorption of long wavelength ultraviolet radiation.

24. The coating composition of claim 1, wherein the coating composition is comprised of from 0.1 to 10 percent by weight of photoinitiator d).

25. The coating composition of claim 1, wherein the coating composition is comprised of not more than 1% by weight in total of non-reactive solvent and water.

26. A method of forming a soft touch coating on a surface of a substrate, comprising applying a layer of the coating composition of claim 1 to at least a portion of the surface and curing the coating composition by irradiation.

27. The method of claim 26, wherein the substrate is comprised of a material selected from the group consisting of thermoplastics, thermoset resins, ceramics, cellulosic materials, leather and metals.

28. The method of claim 26, wherein the layer of the coating composition has a thickness of from 10 to 75 microns.

29. The method of claim 26, wherein the curing is performed by exposing the coating composition to at least one source of radiation selected from ultraviolet radiation and/or electron beam radiation.

30. The method of claim 26, wherein the layer of the coating composition is cured by first exposing the layer of the coating composition to long wavelength ultraviolet radiation and then exposing the layer of the coating composition to short wavelength ultraviolet radiation and wherein the coating composition is comprised of at least one photoinitiator which absorbs both long and short wavelength ultraviolet radiation or is comprised of a first photoinitiator which absorbs long wavelength ultraviolet radiation and a second photoinitiator which absorbs short wavelength ultraviolet radiation.

31. A substrate having a soft touch coating obtained by curing a coating composition in accordance with claim 1.
